(19) United States
(12) Patent Application Publication
(10) Pub. No.: US 2007/0113219 A1
(43) Pub. Date: May 17, 2007

(54) Representing simulation values of variable in sharpley limited time and space

(75) Inventor: Donn S. Terry, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/282,878

(22) Filed: Nov. 17, 2005

(51) Int. Cl. G06F 9/44

(52) U.S. Cl. 717/135

(57) ABSTRACT

A simulation environment which limits the information stored about a variable's value is provided. The stored information can include a single full-range number and a small enumeration of information known about that value (e.g., equal to, not equal to, less than, greater than and/or unknown). With the addition of context information and a carefully constructed set of transition/combination tables, the accuracy of simulation in the simulation environment can be very high with very little information being stored or tested each time a simulated variable is accessed.

### BACKGROUND

Software development can be an intense and complex process. Computer programmers create computer programs by editing source code files and passing these files to a compiler program to create computer instructions executable by a computer or processor-based device. Due to the complex nature of software, tools such as checker(s), debugger(s) and static analysis tools have been developed to simulate the execution environment. These tools can facilitate identification of programming anomaly(ies) (e.g., bugs).

Conventional checker(s) typically trace the flow of values in the code and compute a set of properties/relations of these values. At particular points in the program under analysis, these checker(s) check certain condition(s) using the computed properties, such as that a parameter is not null etc.

Static analysis tool(s) can detect certain kinds of errors in source code, errors that are not easily found by the typical compiler or by conventional testing. For example, static analysis tool(s) can simulate execution of possible code path(s) (e.g., on a function-by-function basis), including code paths that are rarely executed during run time. Using static analysis, possible code path(s) can be checked against a set of rules that identify potential errors and/or bad coding practices. Results of the static analysis can be provided to a user (e.g., programmer) via a user interface and/or log.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A simulation environment is provided. The simulation environment can be employed to detect certain kinds of errors in source code, errors that are not easily found by the typical compiler and/or by conventional testing. The simulation environment can receive a source code file as an input (e.g., the file does not need to be linked or run). For example, the code can be written in C or C++. The source code file can then be “compiled” such that an interpreter can run all code paths.

The simulation environment can simulate execution of possible code path(s) (e.g., on a function-by-function basis), including code paths that are rarely executed during run time. With the simulation environment, code path(s) can be checked against a set of rules that identify potential errors and/or bad coding practices.

The simulation sharply environment limits the information kept about a variable's value, for example, to a single full-range number and a small enumeration of information known about that value (e.g., equal to, not equal to, less than, greater than and/or unknown). With the addition of context information and a carefully constructed set of transition tables, the accuracy of simulation in the simulation environment can be very high with very little information being stored or tested each time a simulated variable is accessed.

The environment includes a variable simulation information store that stores information associated with a variable (e.g., integer). The stored information can include a single number (e.g., full range) and an enumeration of relationship information known about the value of the variable, as described more fully below. Further, the environment further includes a simulation component that simulates execution of a program based, at least in part, upon information stored in the variable simulation information store.

The simulation environment can handle relations other than equality and inequality, and make further inferences on the values after arithmetic has been performed and subsequent comparisons made. The simulation environment can yield much faster results than conventional simulation environments with a similar level of simulation accuracy.

The simulation environment can optionally employ one or more transition tables to affect control flow of the simulation. The transition tables can be associated with operation(s) for: x<y, x<=y, x>y, x>=y, x==y, x+y, x−y, x*y, x/y and/or x % y, where x is a value of a first variable and y is a value of a second variable.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features of the claimed subject matter may become apparent from the following detailed description when considered in conjunction with the drawings.

### BRIEF DESCRIPTION OF THE DRAWINGS

FIG. 1 is a block diagram of a simulation environment.

FIG. 2 is a block diagram of a simulation environment.

FIG. 3 is a block diagram of a simulation environment.

FIG. 4 is flow chart of a method of simulating program execution.

FIG. 5 illustrates an example operating environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the claimed subject matter.

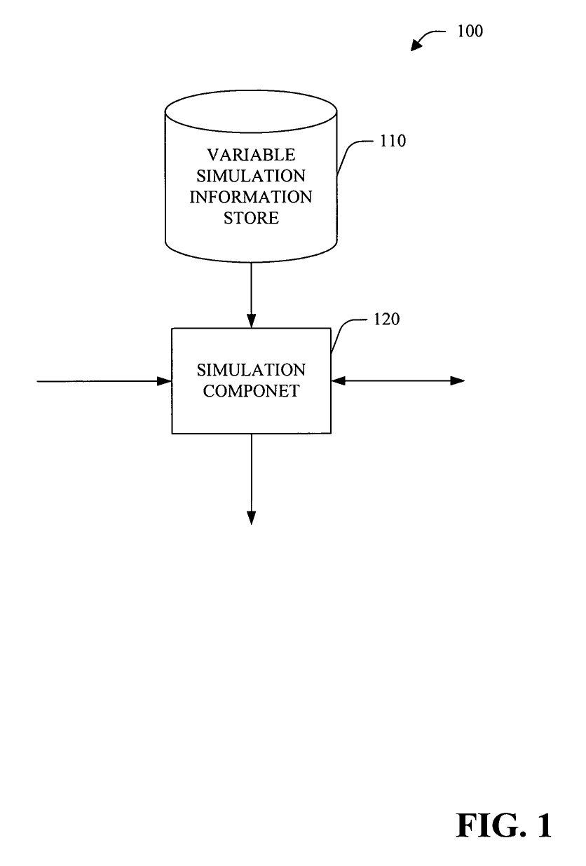

Referring to FIG. 1, a simulation environment 100 is illustrated. The simulation environment 100 can be employed to detect certain kinds of errors in source code, errors that are not easily found by the typical compiler and/or by conventional testing. The simulation environment 100 can receive a source code file as an input (e.g., the file does not need to be linked or run). For example, the code can be written in C or C++. The source code file can then be “compiled” such that an interpreter can run all code paths.

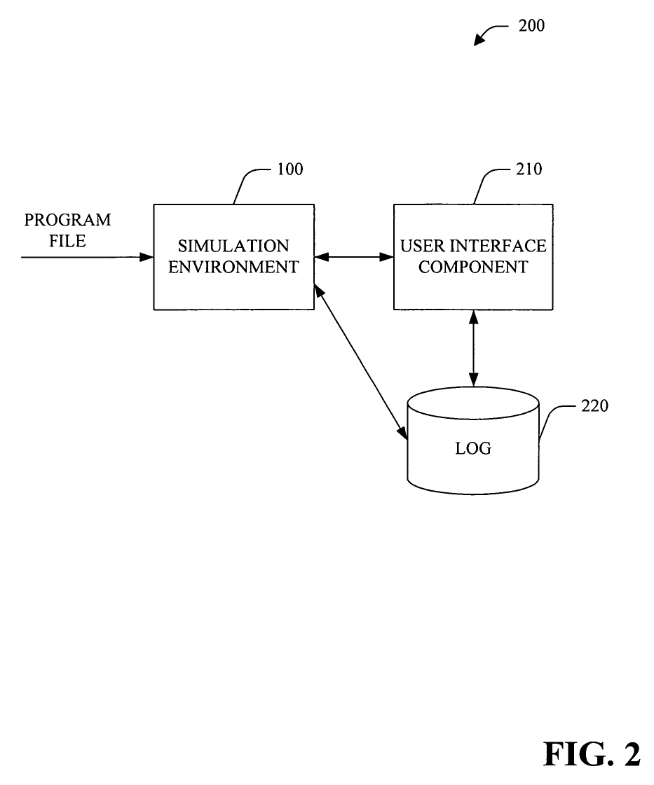

The simulation environment 100 can simulate execution of possible code path(s) (e.g., on a function-by-function basis), including code paths that are rarely executed during run time. With the simulation environment 100, code path(s) can be checked against a set of rules that identify potential errors and/or bad coding practices. Referring briefly to FIG. 2, results can be provided to a user (e.g., programmer) via a user interface component 210 and/or log 220.

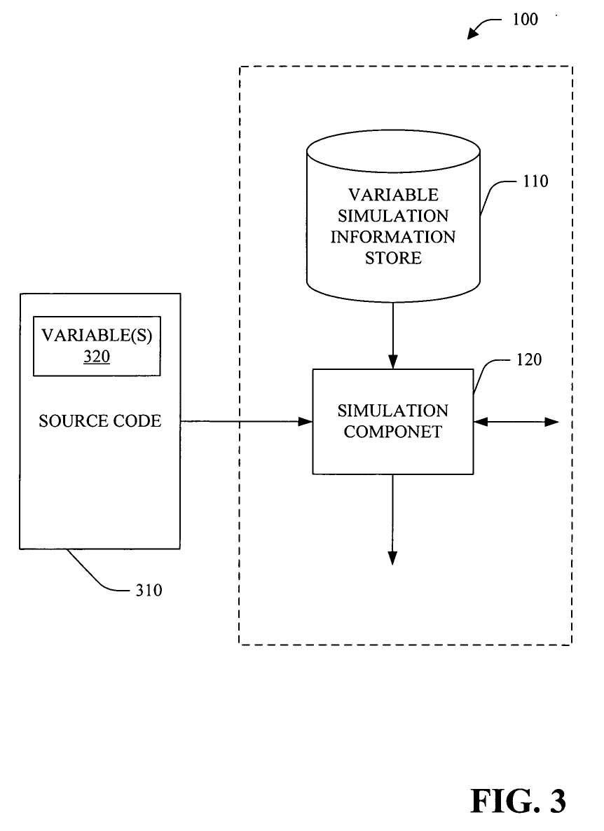

As illustrated in FIG. 3, a source code file 310 can include variable(s) 320. The value of variable(s) 320 can affect the flow of the program. The simulation environment 100 can gather and store information about variable(s) 320 to affect the flow of the program, in order to identify bug(s) and/or problem(s) of the source code file 310, if any.

Referring back to FIG. 1, when simulating program flow for static analysis, there is a performance tradeoff between accuracy of representation about the knowledge inferred about the values of variables from program flow and the performance of the simulation. The more information that is carried through the simulation, the more accurate the simulation, but every increase in information impacts the performance of an already slow process. The simulation environment 100 sharply limits the information kept about a variable's value, for example, to a single full-range number and a small enumeration of information known about that value. For example, with the addition of context information and a carefully constructed set of transition tables, as discussed below, the accuracy of simulation in the simulation environment 100 can be very high with very little information being stored or tested each time a simulated variable is accessed.

The environment 100 includes a variable simulation information store 110 that stores information associated with a variable (e.g., integer). The stored information can include a single number (e.g., full range) and an enumeration of relationship information known about the value of the variable, as described more fully below.

Further, the environment 100 further includes a simulation component 120 that simulates execution of a program based, at least in part, upon information stored in the variable simulation information store 110. For example, consider code that contains a sequence of the form:

TABLE 1

if (a= =6)
{

// something

}
...
if (a= =6)
{

// something else

}

Given that at the beginning of the sequence, a is unknown, it improves the accuracy of the simulation to be sure that both the first and second tests of a yield the same result. It may also be important to know that α is 6 inside one of the ranges, for items such as bounds checking.

This gets more difficult when relational operators are involved: if the expressions above were (a>4) and (a<6), the determination becomes more complex. As additional tests are applied, some tests may further refine the value, some tests may not.

Conventional simulation environments keep either a list of assertions about the value of a variable and/or attempt to represent the value with a “representative” value. The list of assertions solution is as accurate as it is possible to be, but because there are often several assertions, it requires a fairly sophisticated interpreter to arrive at a true or false conclusion about the value based upon multiple assertions.

At the other extreme, a single value can be assigned as “representative”. If equality comparisons are being made, this is obvious and easy. However, given the very common situation below:

TABLE 2

status = function(....);
if (!NT_SUCCESS(status))
{

if (status = = STATUS_NOT_FOUND)
{

//...

}
if (status = = STATUS_TOO_BIG)
{

//...

}

}

In the example of Table 2, NT_SUCCESS is a test that the argument is greater than or equal to zero. So in this case, a representative value might be −2 (since it failed). However, none of the actual possible values for status are −2, so, in this example, none of the “if clauses” will be investigated. That is, in general, there is no one representative value that will work and not cause some paths to be ignored.

With the simulation environment 100, the failure discussed above is avoided and only a small amount of information beyond that representing the value (if it was known) is actually needed. Accordingly, only a very small amount of information is kept, but it is for practical purposes as effective as a larger amount. In particular, the simulation environment 100 can handle relations other than equality and inequality, and make further inferences on the values after arithmetic has been performed and subsequent comparisons made. The simulation environment 100 can yield much faster results than conventional simulation environments with a similar level of simulation accuracy.

When representing integer variable(s) in a simulation environment, a collection of information about the variables(s) can be represented. In the most general case, each comparison that refines the environment's knowledge of the value of a variable reduces the number of possible values, but does so by creating a set of bounded ranges. The value of handling those bounded ranges is limited in the context of static analysis, and can become expensive to maintain.

Thus, in one example, the environment 100 limits the information stored about an integer variable to a single integer value and an enumeration of information known about the value of the variable (e.g., relationship to the value). By doing so, the environment 100 can simplify the problem significantly, without losing a significant amount of simulation accuracy.

Stored Information

The information can be stored in the variable simulation information store 110 and includes value(s) of variable(s) (e.g., not the variable(s) themselves). For example, a notation for values represented this way is set forth in Table 3.

TABLE 3

| Value | Notation: | Example (using 5) |
|---|---|---|
| exactly x | EQx | EQ5 |
| <x | LTx | LT5 |
| >x | GTx | GT5 |
| ! = x | NEx | NE5 |
| unknown | UK | UK |

In this example, since integer variable(s) are involved, “<=y” is the equivalent of “<(y+1)” and “>=y” is the equivalent of “>(y−1)”. For values at the end of numeric ranges, the environment 100 can convert y<=+infinity or y>=−infinity to “unknown”, allowing the environment 100 to avoid weak relationals completely. Disallowing weak relational operations simplifies the problem significantly.

In one example, a distinction can be made by the simulation environment 100 between unknown and “complex” (value in principle knowable, but not known). In this example, both complex and unknown are implemented so all such values are unequal, and they have distinct values (e.g., in the high bits) to keep them from equaling each other.

Transition Tables

For purposes of explanation, a pair of number lines which reflect the possible values of two operands can be utilized. For example, for values i and j, consider values LTi and GTj contained in variables x and y, respectively:

TABLE 4

<----------------- i x
j-----------------------> y

In the example of Table 4, x and y have overlapping ranges, and no specific relationship between x and y can be concluded. That is, a specific value of x could in principle be less than, equal to, or greater than a possible value of y.)

If, however, the relationship between x and y can be represented as:

TABLE 5

<---------i x
j-----------> y

In the example of Table 5, it is the case that the relationship x<y is always true, because there are no possible values for x that are larger than (or equal to) the possible values for y.

Continuing with this example, if the values for x and y are both LT or both GT, then there is no possibility of determining a value, as the ranges must always overlap. If both are EQ, they behave like ordinary numbers.

While it is tempting to try to conclude that if x and y are LTi and GT(i−1) (that is, they have a single point of intersection) that a stronger conclusion can be drawn. However, since this notation represents the possible range, this is just another case where the ranges overlap, and no conclusion can be drawn. Note also that when > is applied to a LT operand, or vice-versa, that no inference at all can be made, since the whole number line is specified.

Table 6 below indicates the inferences that can be made by the simulation component 120 based solely on a pair of values of i and j, independent of the operator being applied to them. If the expression is true about i and j, then a definite value of a comparison operator can be inferred. If it is false, then nothing can be concluded about the relationship of i and j. In Table 6, “any” indicates the value of all relations is known. Further, “none” indicates that no conclusion can be drawn from this information alone; in the case of NE, the exact operation may permit some further inferences. (Note that if the operator being evaluated is <or> (that is, equality is excluded) then when the result is false, the equality case should be included.) Finally, cells with a diagonal through them are inaccessible when the rule that the “weaker” object is on the left, where the order (from weakest to strongest) is taken to be UK, NE, LT, GT, EQ (e.g., technically, LT and GT are equal in strength, however, but only one can be strongest, for the example of Table 6, “LT” was chosen as stronger).

TABLE 6

i

| j | LT | GT | EQ | NE | UK |
|---|---|---|---|---|---|
| LT | None | (i > j) | (i > j) | none | none |
| GT | (i < j) | none | (i < j) | none | none |
| EQ | (i < j) | (i > j) | any | i = = j | none |
| NE | None | none | i = = j | i = = j | none |
| UK | None | none | none | none | none |

Further reasoning about this type of number yields the concept of bounded region. As illustrated in Table 7 (which represents the most general case), the number line can be divided into three regions:

TABLE 7

```
          | |
<----|---------- i x
          j-----------|-------> y
          | |
```

The computed result is different in each region, as a function of the operator being applied to x and y. If i and j have values such that Table 6 applies, then the result is known. That is, in this example, it is the case that it is the leftmost or rightmost half-line where the value is known a priori.

This leaves two regions, the bounded region and the other half-line. For a given relational operator, that operator will be true in one of those regions, and false in the other. For example, continuing with the number lines of Table 7, in the situation in which x is LTi and y is GTj, then the relation x>y will be always false when i<j, but may be either true or false when i>=j.

In the most general case (where the ranges of i and j overlap), when the simulation component 120 has a Boolean variable with an unknown value, the simulation component 120 can try it with each value. In this situation, a reverse inference on the value of one of the terms can be made from the value of the other term. Based upon the Boolean value the simulation component 120 chooses one of the two remaining regions on the number line of Table 7 will have been chosen.

Continuing with the example of x>y above, if it is chosen that the Boolean result will be false, then the actual value for x must be less than j, and thus LTj applies to x. Since LTi already applies to x, then x must be less than the minimum of i and j. Since it is also known that j<i (otherwise the simulation component 120 would not be making “arbitrary choices”), it can be inferred that the value of x as LTj, further constraining the possible values of x.

If the Boolean result is chosen to be true, then the simulation component 120 constrains the actual value for x to be between i and j, that is !LTj and LTi apply to x. This is a bounded region.

Note that for either <or>, and for cases when one of x or y is LT and the other is GT, the two half lines will have opposite Boolean values (one deterministic, one arbitrary). The bounded region will, consequently, match one or the other.

This notation does not handle bounded regions but a partial soluation is described below. In one example, the simulation component 120 chooses a fallback that can be represented. Using the principle of locality as a guide (and somewhat reinforced by experience), once a value has been eliminated as a possibility for a given variable, it is not reintroduced. That is, if the simulation component 120 first tests for x<6 and subsequently tests for x>3, having 7 in the set of possible values for x can be worse than leaving 2 in that set.

There is a special case of bounded region that can be handled by this notation: if the directions and values of the numbers are exactly right, a bounded region of size 1 can be created, which can be converted to an EQ. That is, given GT5 and LT7, they have exactly 6 in common, and the result can then be EQ6. Those skilled in the art will recognize that that not all combinations lead to useful results, and that in some cases the best that can be done is that no further inference is possible.

When computing a result of a comparison of this type of value, there are multiple return results.
If the value can be determined, the appropriate true/false value.
If the value cannot be determined, a new reverse inference value of this type may be found to apply to one of the operands. (In particular, if one of the terms is a constant, then inferences about the other term are particularly meaningful.) The possibilities are:
   i. A new value of this type (that simply further refines the range)
   ii. A bounded region; handled as above.
   iii. An indication that no further refinement is meaningful. (In particular, if one operand is an EQ, then there's no further refinement possible of that operand.)

In one example, the simulation component 120 can employ the truth tables for < > and = under this algebra as set forth in Tables 8-17 below. Significantly, there are a number of directions of symmetry in these tables: the obvious symmetry between < and >, and <= and >=, and the complementary symmetries of <= and >, and >= and <. There are also symmetries on the diagonal of each table, and symmetries imposed by the nature of the underlying notation. All these symmetries help assure that the tables are correct, but identifying the particular symmetry that applies is difficult. Careful analysis of the symmetries is required to assure they are correct. Because inferences can only work in one direction, they tend to obscure otherwise obvious symmetries.

The tables have been filled in to maximize the visibility of symmetries (e.g., sometimes at the expense of other kinds of elegance). Note also that the <= and >= tables are not strictly necessary, as they can in principle be derived from the < and > tables. However, since there are two distinct ways to derive the weak relation tables (both of which yield the same result), the symmetries involved help create confidence in the correctness of the tables. For example, a<=b can be derived as either a!>b or (for integer a and b) as a<(b+1).

The additional specialization for size-one bounded regions is added as notes. This is simplified slightly by keeping separate weak relation tables. Note that only bounded regions for which a new inference can be drawn are noted; there are additional bounded regions which, for various reasons, use the same inference as the adjacent unbounded case, and are already coalesced in the table. This particularly applies to the LT > and GT < cases, where no inference at all can be drawn. Also note that if (algebraically) a<b<c, then a<c−1. That is, 3<4<5, then 3<(5−1).

With respect to Table 8-17, each cell contains three entries: the upper entry is the value reported if a known value can be deduced (as discussed above)—the expression has been retained for readability. No entry (−) implies that no conclusion can be drawn from the values alone (or the cell is otherwise unreachable). The lower entry is a pair of values, separated by /, that would be returned if making an inference applied to the object with the value i from the object with the value j. That is for x<y, where x contains i and y contains j, then we can try to infer a further refined value for x based upon i and j. The left of each such pair is the value that would be used when assuming the Boolean to be true, and the right is that used when assuming false.

If min or max is used instead of i or j, it refers to the minimum or maximum of i and j, as appropriate, except that if the inference would weaken the relationship, it is not applied. That is, if max of GT6 and GT4 is indicated (in that order), the inference is not applied because the stronger GT6 would be overridden with GT4.

In this example, if only a single value appears in the lower half of the cell, it will be the old value of i, indicating that no better inference is possible. Note: LTi, EQi, and GTi in the table bodies are often no-ops, but are represented that way for clarity. Finally, !LTx is translated to GT(x−1), and !GTx is translated to LT(x+1).

Table 8 represents information employed by the simulation component 120 for operation x<y where x is ??i and y is ??j. The inference is on i (i is on the left), so j can be a constant.

TABLE 8

| | i | | | | |
|---|---|---|---|---|---|
| j | LT | GT | EQ | NE | UK |
| LT | — | (i + 1 >= j) −> F | (i >= j) −> F | — | — |
| | LT(min − 1)/LTi | GTi | EQi | (1) | LT(j − 1)/UK |
| GT | (i − 1 <= j) −> T | — | (i < j) −> T | — | — |
| | LTi/(4) | GTi/GT(max) | EQi | (2) | UK/GTj |
| EQ | (i − 1 <= j − 1) −> T | (i + 1 >= j) −> F | (i < j) | not useful | — |
| | LTj/(5) | GTi/(6) | — | (3) | LTj/!LTj |
| NE | — | — | not useful | not useful | — |
| | LTi | GTi | EQi | NEi | UK |
| UK | — | — | — | — | — |
| | LTi | GTi | EQi | NEi | UK |

(1)i < j ? NEi/NEi; i >= j ? LT(j − 1)/NEi
(2)i <= j ? NEi/!LT(j + 1); i > j ? NEi/NEi
(3)i < j ? NEi/!LTj; i = = j ? LTj/GTj; i > j ? LTj/NEi
(4)Bounded region: i − 1 = = j + 1 ? EQ(j + 1): LTi
(5)Bounded region: i − 1 = = j ? EQj/LTi
(6)GT(max(i, j − 1) (which due to prior test is GT(j − 1))

Next, Table 9 refers to the operation x<=y where x is ??i and y is ??j. (Should be the inverse of x>y, and also the same as x<(y+1).)

TABLE 9

| | i | | | | |
|---|---|---|---|---|---|
| j | LT | GT | EQ | NE | UK |
| LT | — | (i + 1 >= j + 1) −> F | (i >= j) −> F | — | — |
| | LT(min)/LTi | GTi | EQi | (1) | LTj/UK |
| GT | (i − 1 <= j + 1) −> T | — | (i < j) −> T | — | — |
| | LTi/(4) | GTi/GT(max + 1) | EQi | (2) | UK/GT(j + 1) |
| EQ | (i − 1 <= j) −> T | (i + 1 >= j + 1) −> F | (i <= j) | not useful | — |
| | (6)/LTi | (5)/GT(max) | — | (3) | !GTj/GTj |
| NE | — | — | not useful | not useful | — |
| | LTi | GTi | EQi | NEi | UK |
| UK | — | — | — | — | — |
| | LTi | GTi | EQi | NEi | UK |

(1)i < j ? NEi/NEi; i >= j ? LTj/NEi
(2)i <= j ? NEi/GT(j + 1); i > j ? NEi/NEi
(3)i < j ? NEi/GT(j + 1); i = = j ? LTj/GTj; i > j ? !GT(j + 1)/NEi
(4)Bounded region: i − 1 = = j + 2 ? EQ(j + 2): LTi
(5)Bounded region: i = = j − 1 ? EQj/GTi
(6)j < i ? LT(j + 1): LTi

Table 10 refers to the operation x>y where x is ??i and y is ??j.

TABLE 10

| | i | | | | |
|---|---|---|---|---|---|
| j | LT | GT | EQ | NE | UK |
| LT | — | (i + 1 >= j + 1) −> T | (i > j) −> T | — | — |
| | LTi/LT(min) | GTi | EQi | (1) | UK/LTj |
| GT | (i − 1 <= j) −> F | — | (i <= j) −> F | — | — |
| | (4)/LTi | GT(max + 1)/GTi | EQi | (2) | GT(j + 1)/UK |
| EQ | (i − 1 <= j) −> F | (i + 1 >= j + 1) −> T | (i > j) | not useful | — |
| | LTi/(6) | GTj/(5) | — | (3) | GTj/!GTj |
| NE | — | — | not useful | not useful | — |
| | LTi | GTi | EQi | NEi | UK |
| UK | — | — | — | — | — |
| | LTi | GTi | EQi | NEi | UK |

(1)i < j ? NEi/NEi; i >= j ? NEi/!GT(j − 1)
(2)i <= j ? GT(j + 1)/NEi; i > j ? NEi/NEi
(3)i < j ? GTj/NEi; i = = j ? GTj/LTj; i > j ? NEI/!GTj
(4)Bounded region: i − 1 = = j + 2 ? EQ(j − 1)/LTi
(5)Bounded region: i = = j − 1 ? EQj/GTi
(6)GT(max(i, j + 1) (which due to prior test is GT(j + 1).

Table 11 refers to the operation x>=y where x is ??i and y is ??j. (Should be the inverse of x<y, and also the same as x>(y−1)).

TABLE 11

| | i | | | | |
|---|---|---|---|---|---|
| j | LT | GT | EQ | NE | UK |
| LT | — | (i + 1 >= j) −> T | (i > j) −> T | — | — |
| | LTi/LT(min − 1) | GTi | EQi | (1) | UK/LTj |
| GT | (i − 1 <= j) −> F | — | (i <= j) −> F | — | — |
| | (4)/LTi | GT(max)/GTi | EQi | (2) | GTj/UK |
| EQ | (i − 1 <= j − 1) −> F | (i + 1 >= j) −> T | (i >= j) | not useful | — |
| | (5)/LT(min) | (6)/GTi | — | (3) | !LTj/LTj |
| NE | — | — | not useful | not useful | — |
| | LTi | GTi | EQi | NEi | UK |
| UK | — | — | — | — | — |
| | LTi | GTi | EQi | NEi | UK |

(1)i < j ? NEi/NEi; i >= j ? NEi/LT(j − 1)
(2)i <= j ? GTj/NEi; i > j ? NEi/NEi
(3)i < j ? GTj/NEi; i = = j ? GTj/LTj; i > j ? NEI/!GTj
(4)Bounded region: i − 1 = = j + 1 ? EQ(j − 1)/LTi
(5)Bounded region: i − 1 = = j ? EQj/LTi
(6)j > i ? GT(j − 1): GTi

Table 12 relates to the operation x=y where x is ??i and y is ??j. For operation x!=y: the simulation component 120 can invert the truth values, and reverse the inference values.

TABLE 12

| | i | | | | |
|---|---|---|---|---|---|
| j | LT | GT | EQ | NE | UK |
| LT | — | (i − 1 > j) −> F | (i > j) −> F | — | — |
| | LT(min)/LTi | GTi | EQi | (1) | LTj/!LTj |
| GT | (i − 1 <= j) −> F(4) | — | (i < j) −> F | — | — |
| | LTi | GT(max)/GTi | EQi | (2) | GTj/!GTj |
| EQ | (i <= j) −> F | (i >= j) −> F | (i = = j) | (i = = j) −> F | — |
| | EQj/(4) | EQj/(5) | — | NEi/EQj | EQj/NEj |
| NE | — | — | (i = = j) −> F | not useful | — |
| | LTi | GTi | EQi | NEi | NEj/UK |
| UK | — | — | — | — | — |
| | LTi | GTi | EQi | NEi | UK |

(1)i < j ? NEi/NEi; i >= j ? LTj/NEi
(2)i <= j ? GTj/NEi; i > j ? NEi/NEi
(3)Bounded region: i − 1 = = j + 1 ? −> T, EQ(j + 1)
(4)Edge region: i − 1 = = j ? LT(i − 1): LTi
(5)Edge region: i + 1 = = j ? GT(i + 1): GTi

Table 12 has a cell that is particularly instructive, the NE/NE case. Even if i and j are the same, no conclusion can be drawn: they might both be required to be not 6, but they both could be (say) 9 (or not) (see also UK/NE).

Next, with respect to arithmetic operations, the following formulas can be used to explain the tables:
LTi+LTj is (i−1)+(j−1)+1 or i+j−1.
GTi+GTj is (i+1)+(j+1)−1 or i+j+1.

Table 13 refers to the operation x+y where x is ??i and y is ??j.

TABLE 13

| | i | | | | |
|---|---|---|---|---|---|
| j | LT | GT | EQ | NE | UK |
| LT | LT(i + j − 1) | UK | LT(i + j) | UK | UK |
| GT | UK | GT(i + j + 1) | GT(i + j) | UK | UK |
| EQ | LT(i + j) | GT(i + j) | i + j | NE(i + j) | UK |
| NE | UK | UK | NE(i + j) | UK | UK |
| UK | UK | UK | UK | UK | UK |

Regarding unary minus:
−LTi−>GT(−i)−NEi−>NE(−i)−UK−>UK
−GTi−>LT(−i)−EQi−>EQ(−i)

Next, Table 14 refers to the operation x−y where x is ??i and y is ??j (e.g., the unary minus is applied to j, then added.)

TABLE 14

| | i | | | | |
|---|---|---|---|---|---|
| j | LT | GT | EQ | NE | UK |
| LT | UK | GT(i − j − 1) | LT(i − j) | UK | UK |
| GT | LT(i − j + 1) | UK | GT(i − j) | UK | UK |
| EQ | LT(i − j) | GT(i − j) | i − j | NE(i − j) | UK |
| NE | UK | UK | NE(i − j) | UK | UK |
| UK | UK | UK | UK | UK | UK |

Operation x*y where x is ??i and y is ??j is set forth in Table 15.

TABLE 15

| | i | | | | |
|---|---|---|---|---|---|
| j | LT | GT | EQ | NE | UK |
| LT | UK | UK | (4) | UK | UK |
| | (1) | | | | |
| GT | UK | UK | (5) | UK | UK |
| | | (1) | | | |
| EQ | (2) | (3) | i * j | j = = 0 ? 0: | j = = 0 ? 0: |
| | | | | NE(i * j) | UK |
| NE | UK | UK | i = = 0 ? 0: | UK | UK |
| | | | NE(i * j) | | |
| UK | UK | UK | i = = 0 ? 0: | UK | UK |
| | | | UK | | |

(1)If i and j are both the same sign, in this example, increased accuracy is not deemed worth the computational costs.
(2)j > 0 ? LT((i − 1) * j + 1); j = = 0 ? EQ0; j < 0 GT((i − 1) * j − 1)
(3)j > 0 ? GT((i + 1) * j − 1); j = = 0 ? EQ0; j < 0 LT((i + 1) * j + 1)
(4)i > 0 ? LT((j − 1) * i + 1); i = = 0 ? EQ0; i < 0 GT((j − 1) * i − 1)
(5)i > 0 ? GT((j + 1) * i − 1); i = = 0 ? EQ0; i < 0 LT((j + 1) * i + 1)

The operation x/y where x is ??i and y is ??j is set forth in Table 16:

TABLE 16

i

| j | LT | GT | EQ | NE | UK |
|---|---|---|---|---|---|
| LT | UK (1) | UK | (1)(4) | UK | UK |
| GT | UK | UK (1) | (1)(4) | UK | UK |
| EQ | (2) | (3) | j = = 0 ? error: | (5) | (5) |
| | | | i/j | | |
| NE | UK | UK | (4) | UK | UK |
| UK | UK | UK | (4) | UK | UK |

(1)If i and j are both the same sign, in this example, increased accuracy is not deemed worth the computational costs.
(2)j > 0 ? LT((i − 1)/j + 1); j = = 0 ? error; j < 0 GT((i − 1)/j − 1)
(3)j > 0 ? GT((i + 1)/j + 1); j = = 0 ? error; j < 0 LT((i + 1)/j − 1)
(4)i = = 0 ? 0: UK
(5)j = = 0 ? error: UK

Table 17 refers to the operation x % y where x is ??i and y is ??j.

TABLE 17

i

| j | LT | GT | EQ | NE | UK |
|---|---|---|---|---|---|
| LT | (1) | (1) | i= =0 ? 0:(1) | (1) | (1) |
| GT | UK | UK | i = = 0 ? 0: UK | UK | UK |
| EQ | (2) | (2) | j = = 0 ? error: | (2) | (2) |
| | | | i % j | | |
| NE | UK | UK | i = = 0 ? 0: UK | UK | UK |
| UK | UK | UK | i = = 0 ? 0: UK | UK | UK |

(1)j > 0: LT(j − 1); j = = 0: error; j < 0: GT(j + 1)
(2)j > 0: LTj; j = = 0: error; j < 0: GT(j)

Those skilled in the art will recognize the following heuristic extension. By adding two different kinds of UK values, it is possible to further reduce the noise level from analysis without impacting accuracy. The effect is to cause repeated comparisons between unknown values to yield consistent results in the same simulation pass.

An additional type, notated UU, which is semantically the same as UK above, can be introduced. Variables with unknown values are initially marked as UU, and inferences from the stronger types above are made for both UU and UK without distinction, except when both variables in a comparison are UU or UK. UK variables are given an arbitrary value (which has no intrinsic meaning.) In this example, the following additional rules are applied if both variables in a comparison are UU or UK:
(1) If both are UK, the comparison operation returns the truth value resulting from the appropriate comparison of the two associated arbitrary values. (Consequently, repeated comparisons of the same UK values yield the same truth value.)
(2) If both are UU, one is arbitrarily associated with a constant value (for example, 1000, but any suitable value can be utilized.)
(3) The remaining UK value is given a value which satisfies the condition and the truth value that was selected for the purposes of the simulation. (As above, the inference of the value for unknown values is made after the truth value is determined.)

It is to be appreciated that the environment 100, the variable simulation information data store 110, the simulation component 120, the user interface component 210 and/or the log 220 can be computer components as that term is defined herein.

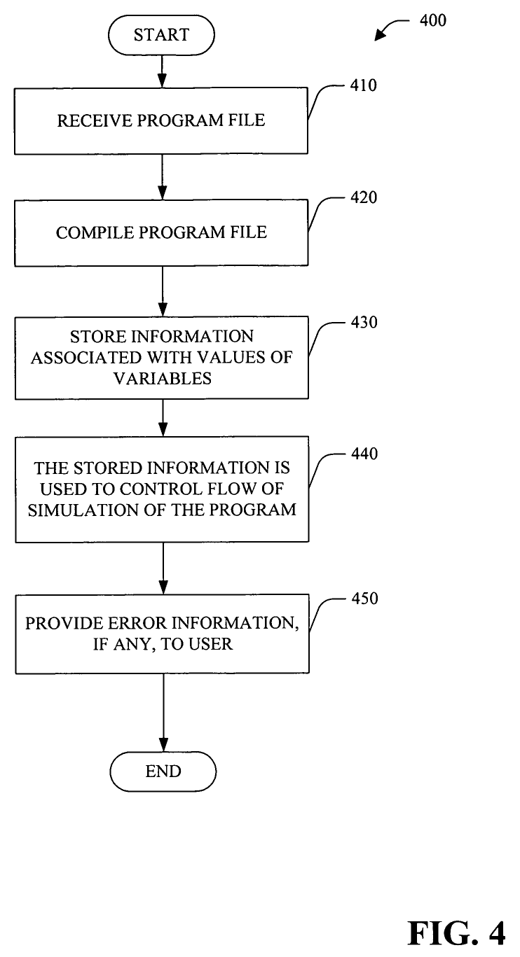

Turning briefly to FIG. 4, a methodology that may be implemented in accordance with the claimed subject matter are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies.

The claimed subject matter may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 4, a method of simulating program execution 400 is illustrated. At 410, a program file is received. At 420, the program file is compiled (e.g., into condition for use by an interpreter). At 430, information associated with values of variables is stored, for example, in a variable simulation information store 110. The stored information can include a constant value and relationship information (e.g., equal to, not equal to, less than, greater than, unknown etc.).

At 440, the stored information is used to control flow of the simulation. For example, independent of the operator being applied, Table 6 above can be applied to control flow of the simulation. Further, based, at least in part, upon a particular operator, one of Tables 8-17 can be applied to control flow of the simulation. At 450, error information, if any, is provided to a user.

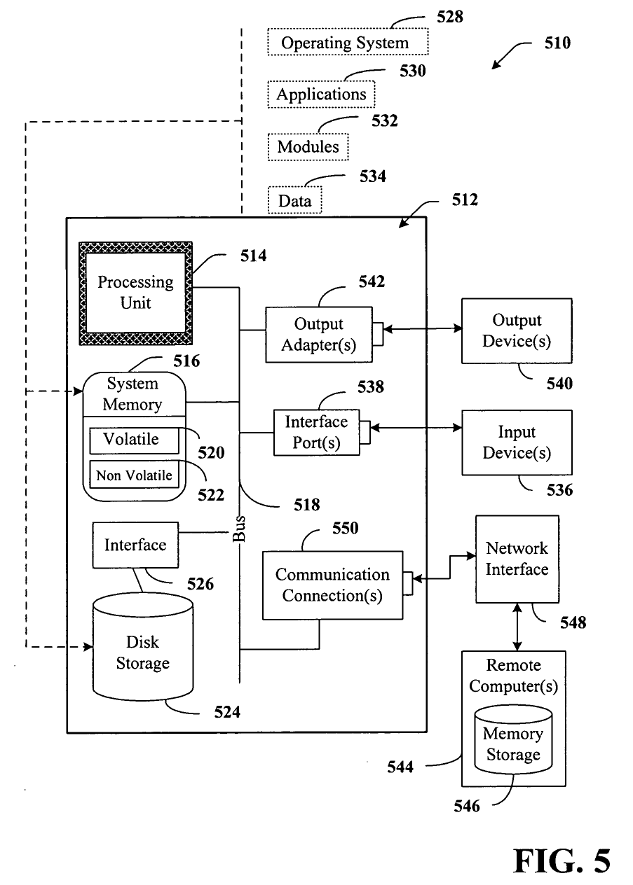

In order to provide additional context for various aspects of the claimed subject matter, FIG. 5 and the following discussion are intended to provide a brief, general description of a suitable operating environment 510. While the claimed subject matter is described in the general context of computer-executable instructions, such as program modules, executed by one or more computers or other devices, those skilled in the art will recognize that the claimed subject matter can also be implemented in combination with other program modules and/or as a combination of hardware and software. Generally, however, program modules include routines, programs, objects, components, data structures, etc. that perform particular tasks or implement particular data types. The operating environment 510 is only one example of a suitable operating environment and is not intended to suggest any limitation as to the scope of use or functionality of the claimed subject matter. Other well known computer systems, environments, and/or configurations that may be suitable for use with the claimed subject matter include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 5, an exemplary environment 510 includes a computer 512. The computer 512 includes a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514.

The system bus 518 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 516 includes volatile memory 520 and nonvolatile memory 522. The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable ROM (EEPROM), or flash memory. Volatile memory 520 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 512 also includes removable/nonremovable, volatile/nonvolatile computer storage media. FIG. 5 illustrates, for example a disk storage 524. Disk storage 524 includes, but is not limited to, devices like a magnetic disk drive, floppy disk drive, tape drive, Jaz drive, Zip drive, LS-100 drive, flash memory card, or memory stick. In addition, disk storage 524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 524 to the system bus 518, a removable or non-removable interface is typically used such as interface 526.

It is to be appreciated that FIG. 5 describes software that acts as an intermediary between users and the basic computer resources described in suitable operating environment 510. Such software includes an operating system 528. Operating system 528, which can be stored on disk storage 524, acts to control and allocate resources of the computer system 512. System applications 530 take advantage of the management of resources by operating system 528 through program modules 532 and program data 534 stored either in system memory 516 or on disk storage 524. It is to be appreciated that the claimed subject matter can be implemented with various operating systems or combinations of operating systems.

A user enters commands or information into the computer 512 through input device(s) 536. Input devices 536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 514 through the system bus 518 via interface port(s) 538. Interface port(s) 538 include, for example, a serial port, a parallel port, a game port, and a universal serial bus (USB). Output device(s) 540 use some of the same type of ports as input device(s) 536. Thus, for example, a USB port may be used to provide input to computer 512, and to output information from computer 512 to an output device 540. Output adapter 542 is provided to illustrate that there are some output devices 540 like monitors, speakers, and printers among other output devices 540 that require special adapters. The output adapters 542 include, by way of illustration and not limitation, video and sound cards that provide a means of connection between the output device 540 and the system bus 518. It should be noted that other devices and/or systems of devices provide both input and output capabilities such as remote computer(s) 544.

Computer 512 can operate in a networked environment using logical connections to one or more remote computers, such as remote computer(s) 544. The remote computer(s) 544 can be a personal computer, a server, a router, a network PC, a workstation, a microprocessor based appliance, a peer device or other common network node and the like, and typically includes many or all of the elements described relative to computer 512. For purposes of brevity, only a memory storage device 546 is illustrated with remote computer(s) 544. Remote computer(s) 544 is logically connected to computer 512 through a network interface 548 and then physically connected via communication connection 550. Network interface 548 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 550 refers to the hardware/software employed to connect the network interface 548 to the bus 518. While communication connection 550 is shown for illustrative clarity inside computer 512, it can also be external to computer 512. The hardware/software necessary for connection to the network interface 548 includes, for exemplary purposes only, internal and external technologies such as, modems including regular telephone grade modems, cable modems and DSL modems, ISDN adapters, and Ethernet cards.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A simulation environment comprising:
a variable simulation information store that stores information associated with a variable, the information comprising a single number and an enumeration of information known about the value of the variable; and,
a simulation component that simulates execution of a program based, at least in part, upon information stored in the variable simulation information store.

2. The environment of claim 1, the variable is of type integer.

3. The environment of claim 1, the enumeration of information known about the value of the variable comprising one of equal to, less than, greater than, not equal to, and unknown.

4. The environment of claim 1, further comprising a compiler such that an interpreter can run code paths of the program.

5. The environment of claim 1, the simulation component executed code path(s) on a function-by-function basis.

6. The environment of claim 1, the simulation component identifies one or more problems associated with the source code.

7. The environment of claim 1, the simulation component utilizes one or more transition tables to affect control flow of the program.

8. The environment of claim 7, the simulation component utilizes a transition table for an operation x<y, where x is a value of a first variable and y is a value of a second variable.

9. The environment of claim 7, the simulation component utilizes a transition table for an operation x<=y, where x is a value of a first variable and y is a value of a second variable.

10. The environment of claim 7, the simulation component utilizes a transition table for an operation x>y, where x is a value of a first variable and y is a value of a second variable.

11. The environment of claim 7, the simulation component utilizes a transition table for an operation x>=y, where x is a value of a first variable and y is a value of a second variable.

12. The environment of claim 7, the simulation component utilizes a transition table for an operation x==y, where x is a value of a first variable and y is a value of a second variable.

13. The environment of claim 7, the simulation component utilizes a transition table for an operation x+y, where x is a value of a first variable and y is a value of a second variable.

14. The environment of claim 7, the simulation component utilizes a transition table for an operation x−y, where x is a value of a first variable and y is a value of a second variable.

15. The environment of claim 7, the simulation component utilizes a transition table for an operation x*y, where x is a value of a first variable and y is a value of a second variable.

16. The environment of claim 7, the simulation component utilizes a transition table for an operation x/y, where x is a value of a first variable and y is a value of a second variable.

17. A method of simulating program execution comprising:
storing information associated with a value of a variable, the information comprising a single number and an enumeration of information known about the value of the variable; and,
using the stored information to control flow of simulation of a program.

18. The method of claim 17, further comprising at least one of the following:
receiving a program file associated with the program;
compiling the program file; and,
providing error information, if any error(s) found

19. A simulation environment comprising:
means for storing information associated with a variable, the information comprising a single number and an enumeration of information known about the value of the variable; and,
means for simulating execution of a program based, at least in part, upon the stored information.

20. The environment of claim 19, the enumeration of information known about the value of the variable comprising one of equal to, less than, greater than not equal to and unknown.
